(19) United States
(12) Patent Application Publication
(10) Pub. No.: US 2011/0095016 A1
(43) Pub. Date: Apr. 28, 2011

(54) Safe product transfer apparatus

(75) Inventors: Roger Schwierking, Cheyenne, WY (US); Diosdado Pangan, Cheyenne, WY (US)

(73) Assignee: Standex International Corporation

(21) Appl. No.: 12/925,333

(22) Filed: Oct. 19, 2010

Related U.S. Application Data
(60) Provisional application No. 61/279,636, filed on Oct. 23, 2009.

(51) Int. Cl. F27D 11/00; H05B 3/02

(52) U.S. Cl. 219/442; 219/469

(57) ABSTRACT

A safe product transfer apparatus that heats refrigerated food products and then hold those heated food products in a hold drawer until they can be transferred to a heater merchandizer, preferably a roller grill as needed. The apparatus features a control assembly. The assembly has a pre-selectable preheat temperature control to provide a preheat temperature when the “on” switch of said control is activated. A pre-heat indicator indicates when the preheat temperature has been reached so that the food products can be loaded into an operable drawer. A pre-selectable heat temperature control provides a heat temperature wherein the heat temperature corresponds to the safe serving temperature. A timer indicator counts down to zero from a pre-set time once the heat temperature control has been activated such that the food products are assured of having reached the pre-selectable heat temperature. Then, the timer counts upward until a pre-set maximum time for holding the food products at a hold temperature is reached. In this manner, consumers are prevented from selecting a food product that hasn't reached the proper safe serving temperature. Consumers are also prevented from selecting a food product that has been held longer at the hold temperature wherein the food product may be degraded in quality. The apparatus can heat a refrigerated product from 34° F. to greater than or equal to 140° F. in 35 minutes or less. The apparatus has a safe product transfer apparatus that has a heating cavity ranging from 250° F. to 425° F. The apparatus provides a safe product transfer apparatus that can hold the products stored therein at a safe holding temperature (ranging from greater or equal to 140° F. to not more than 205° F.), that is, not hot enough to continue heating or degrading the food product.

This application claims benefit of U.S. Provisional Application Ser. No. 61/279,636 filed Oct. 23, 2009 pursuant to 35 USC §119(e).

### FIELD OF THE INVENTION

This invention relates to food processing equipment, in particular, apparatus for preparing food for grilling on a roller grill.

### BACKGROUND OF THE INVENTION

The use of a roller grilling apparatus is well known. Such devices as made by APW Wyott of Dallas, Tex., are able to grill more than five hundred frankfurters an hour. This makes this type of apparatus ideal for serving a large number of people quickly with a minimum number of personnel. Further, since the customers are able to view and smell the products while they are being grilled, it helps to develop appetite appeal so that it is no wonder that the use of such devices for serving ‘hot dogs’ is so ubiquitous.

The universal acceptance of having a grilled frankfurter prepared by such grills has resulted in their use for other food products as well, such as bratwurst, sausage, knockwurst and so on. However, many products taken directly from the refrigerator are not pre-cooked such as is typical for sausages. Therefore, such products are potentially hazardous if they spend too little cooking time on the roller grill before serving. This is particularly a problem in high volume situations where a large number of people are being served in a relatively short period of time such as at sporting events.

Health inspectors, recognizing the potential hazard to customers receiving food that has not been heated throughout to the proper temperature, have taken the position that the merchandizer of such products is in violation of health safety standards. Unless a consistently safe product can be demonstrably provided, the use of roller grills for products that aren't pre-cooked will to be very limited. This will be especially true in high volume locations for roller grills that often do not have sufficient time to heat the products fast enough to meet public demand such as at fairs, ballparks and other venues where the ‘hot dog’ is a signature food choice.

Heating such products on other than roller grills and then transferring them to a roller grill has disadvantages. First, this method often causes unwanted changes in the appearance and desirability of the product. Further, this method also requires additional equipment and presents a space problem during food preparation. Also, there is a requirement of moving the product from the non-roller grill to the roller grill which is located at a distance from the roller grill thus slowing the process as well as risking spills, etc.

A safe product transfer apparatus that is associated with a roller grilling apparatus and re-thermalizes the products to be roller grilled in accordance with food safety requirements and is able to hold such products for an extended time is not found in the prior art.

### SUMMARY OF THE INVENTION

It is an aspect of the invention to provide a safe product transfer apparatus that is a low profile re-thermalization unit that also functions as a hold drawer.

It is an aspect of the invention to provide a safe product transfer apparatus that is associated with a roller grill such that products in the apparatus can be easily transferred to the roller grill as needed.

Another aspect of the invention is to provide a safe product transfer apparatus that is built into a roller griller with no loss of counter space.

Still another aspect of the invention is to provide a safe product transfer apparatus that reduces waste from over cooked products that cannot be sold.

Still another aspect of the invention is to provide a safe product transfer apparatus that can heat a variety of food items at the same time.

Another aspect of the invention is to provide a safe product transfer apparatus that can heat a refrigerated product from 34° F. to greater than or equal to 140° F. in 35 minutes or less.

It is an aspect of the invention to provide a safe product transfer apparatus that has a heating cavity ranging from 250° F. to 425° F.

Another aspect of the invention is to provide a safe product transfer apparatus that can hold the products stored therein at a safe holding temperature but not hot enough to continue heating or degrading the food product.

Another aspect of the invention is to provide a safe product transfer apparatus that is able to hold products up to 6 hours without sacrificing the quality and appearance of the product.

It is an aspect of the invention to provide a safe product transfer apparatus that has a holding temperature ranging from greater than 140° F. to not more than 205° F.

It is still another aspect of the invention to provide a safe product transfer apparatus that has an openable drawer wherein heated products can be removed from the drawer and placed on a heated merchandizer such as a roller grill.

Another aspect of the invention is to provide a safe product transfer apparatus that has a control, preferably a digital control with push button operations.

Finally, it is an aspect of the invention to provide a safe product transfer apparatus that can fit under and/or fit between the legs of a roller grill.

### BRIEF DESCRIPTION OF THE DRAWINGS

FIG. 1 is an isometric view of the safe product transfer apparatus with the drawer in the open position in accordance with the invention.

FIG. 2 is a front view of the apparatus.

FIG. 3 is a detailed view of the control panel of the apparatus.

FIG. 4 is an isometric view of the apparatus with the drawer panel front in place with a roller grill placed on top.

FIG. 5 is an isometric view of an alternative embodiment of the apparatus with a roller grill incorporated therein and the wire rack removed to show the drawer pan.

### DETAILED DESCRIPTION OF THE INVENTION

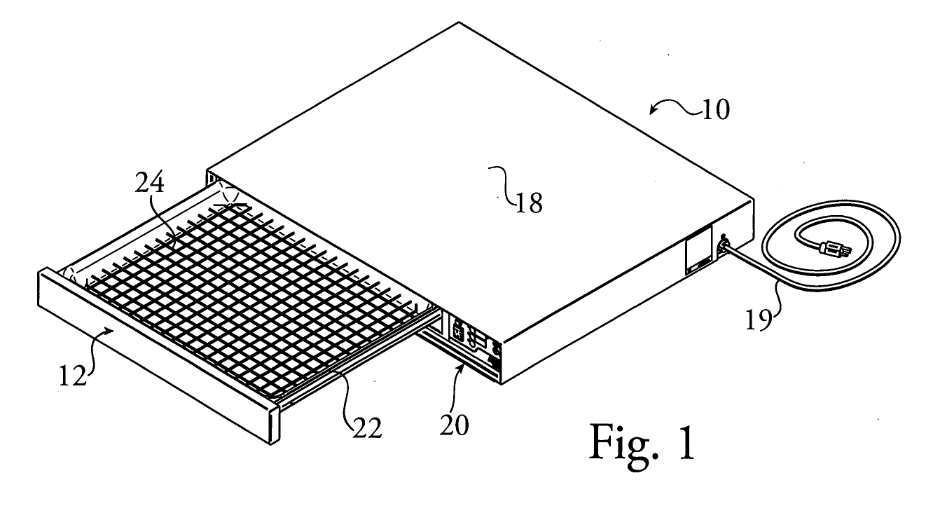

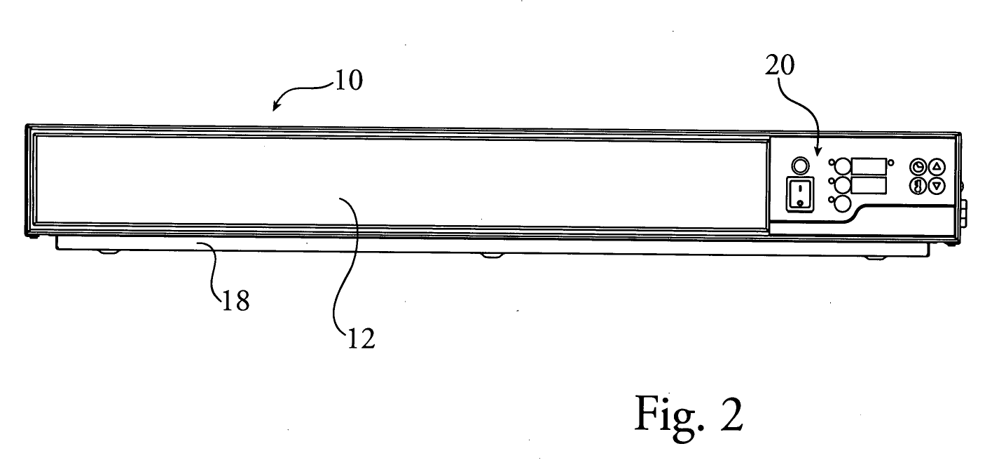

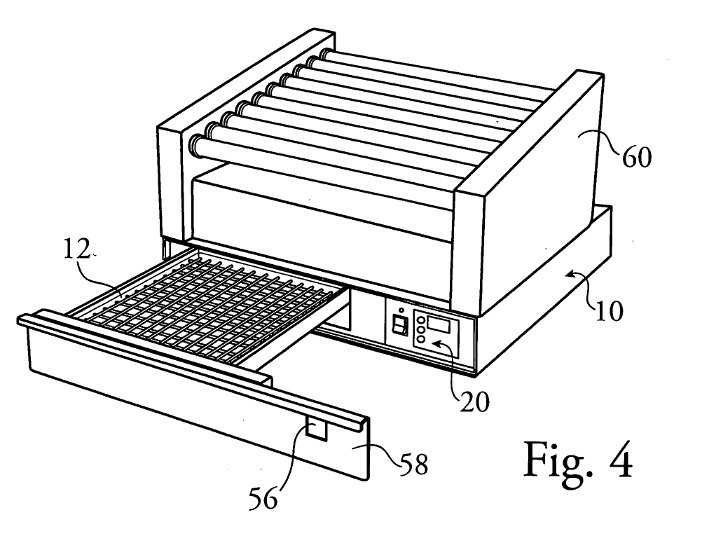

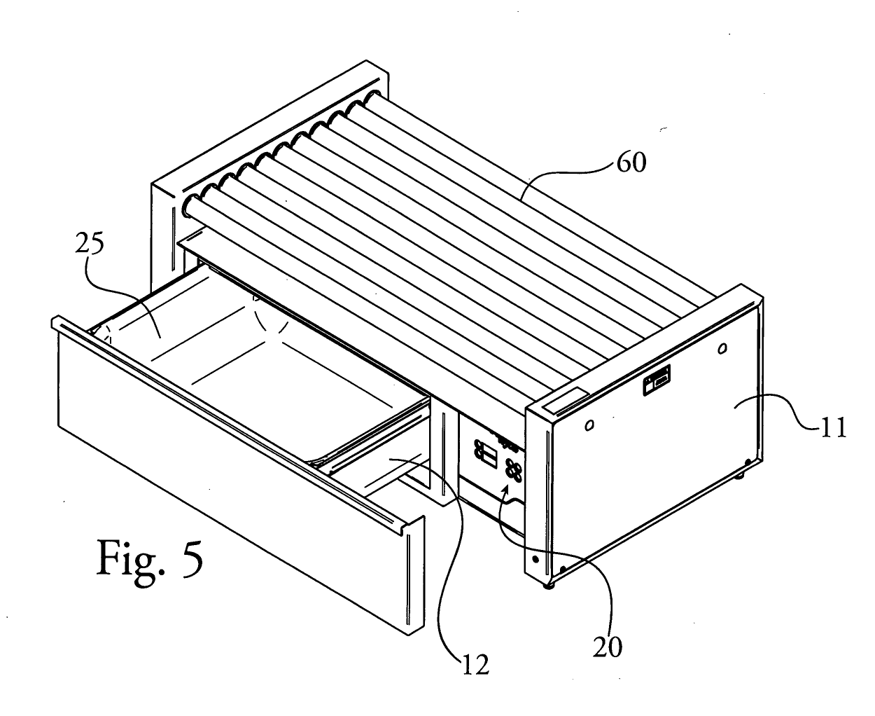

Referring now to FIGS. 1 and 2, invention 10 is shown. Housing 18 is preferably made from stainless steel so that it can be used in cooking environments without rusting and requiring easy cleaning. Safe Product Transfer Apparatus (SPTA) 10 can be made in different sizes depending on the volume of food products that are to be served. It is anticipated that the smallest size will be about 24 inches wide, about 5 inches high, and 27 inches deep. SPTA 10 is powered by regular 120 volt, 60 Hz service via power cord 19. Drawer 12 is slid into SPTA 10 via rails 22. Inside drawer 12 is a stainless steel removable pan 25 (See FIG. 5) with wire grid 24 placed thereon. One unique aspect of SPTA 10 is control assembly 20 that is described in detail below. SPTA 10 is designed as a stand-alone unit that can fit on a counter top under a user's present roller grill, therefore, resulting in no loss of counter space. (See FIG. 4) It can also be fitted with legs so that it can fit under a freestanding roller grill (not shown). Further, it can be integrated so that the invention can combine SPTA 10 and roller grill 60 into a single unit. (See FIG. 5)

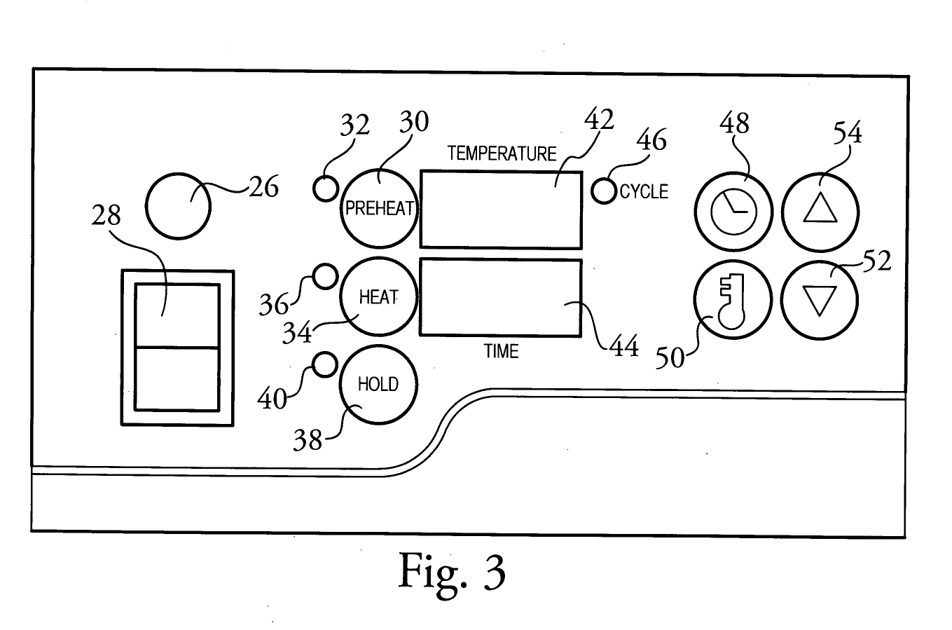

Referring now to FIG. 3, a detailed view of control assembly 20 is shown. This unit is able to heat/re-thermalize products such as hot dogs, bratwurst, knockwurst, kielbasa, sausage, etc. 61 and remain automatically changes to “HOLD temperature” where products 61 them at the optimum temperature for a period of hours until they can be grilled on the associated roller grill 60. A variety of products 61 can BE placed in SPTA 10 at the same time and then brought to the optimum serving temperature so that they will look the freshest. This improves labor productivity by having pre-set holding times. Further, it ensures that product transfer from SPTA 10 to roller grill 60 will be swift, safe and meet governmental sanitary rules.

In operation, SPTA 10 is turned on via rocker switch 28. Once on, pilot light 26 is lit but display 42 reads “OFF” to indicate the temperature of SPTA 10 has not been activated as yet. PREHEAT touch pad 30 is pressed and SPTA 10 to either the previous preheat temperature that has been set or a default factory setting if no previous setting has been entered. PREHEAT indicator light 32 becomes lit to indicate the unit is in the preheat stage. When the preheat temperature is reached, the unit beeps and display 42 shows “RDY” to indicate that the unit is ready. Further, HEAT indicator light 36 flashes to prompt the user to load food into drawer 12.

After the food is loaded, the user presses HEAT touch pad 34 and indicator light 36 is lit steady. Timer display 44 begins to count down from the pre-set or default time until the timer indicates 00:00. When timer display 44 reaches zero, the unit beeps and the unit auto-advances to the “HOLD” mode at the “HOLD” temperature, again that is pre-set or is a manufacturer default temperature. Timer display 44 now starts counting upwards. During the “HOLD” mode, indicator light 40 is lit to indicate that this stage is occurring.

Once the maximum “HOLD” time is reached, the unit flashes the time on display 44 and beeps every 30 seconds and flashes the indicator light 40 until any key is pressed to acknowledge and stop the beep. The heat to the unit is then turned off, and the display 42 says OFF.

By use of the SPTA 10, a customer or user is prevented from selecting a cold product that may have just been placed on the roller grill since all products that are now on the roller grill have reached proper serving temperature in the SPTA 10.

The temperature and time settings can be adjusted in accordance with user preferences. The PREHEAT time has no adjustment as changes in the HEAT temperature automatically adjusts the PREHEAT time to match the HEAT temperature. However, it is possible to manually adjust the HEAT and HOLD time and temperature.

With the unit in the OFF position, press and hold the desired touch pad (HEAT or HOLD) for 3 seconds. Display 42 flashes. Adjust the time or temperature up or down using touch pads 52 and 54 accordingly. Press time touch pad 48 to adjust the time to accept and advance. Press temperature touch pad 50 to adjust the temperature to accept and advance. Again press temperature touch pad 50 or time touch pad 48 to accept the new setting and unit then displays OFF.

For an unlimited HOLD time, increase the hold time to the maximum setting and the next increment is infinite. There is also a heat bypass capability by setting the HEAT time to zero. The HEAT is bypassed and unit goes directly from PREHEAT to HOLD.

Pressing time key 48 during operation will show the following: During HEAT mode, the original time setting. During HOLD mode, the elapsed HOLD time is indicated. After maximum HOLD time has been reached, the unit is turned OFF.

Pressing the HEAT key 50 during operation will show the following: During PREHEAT, HEAT, and HOLD mode, the actual temperature in drawer 12 is indicated. If pressed after maximum HOLD time has been reached, the unit is turned OFF.

Cycle indicator light 46 remains lit anytime the heating element in SPTA 10 is on.

As shown in FIGS. 4 and 5, drawer cover panel 58 is provided having window 56 to view the displays 42 and 44 but prevents access to touch pads 30, 34, 38, 48 and 50 or up and down touch pads 52 and 54 when drawer 12 is shut. This is done because it is anticipated that the unit will be set on a counter top having the control end exposed where customers might change the settings.

While certain representative embodiments of the invention have been described herein for the purposes of illustration, it will be apparent to those skilled in the art that modification therein may be made without departure from the spirit and scope of the invention.

What is claimed is:

1. A food product heating apparatus comprising:
a housing;
at least one operable drawer adapted to hold a plurality of refrigerated food products that are to be heated to a pre-determined safe serving temperature;
a control assembly having an on/off switch comprising:
a pre-selectable preheat temperature control to provide a preheat temperature when the “on” switch of said control is activated;
a pre-heat indicator that indicates when the preheat temperature has been reached so that the plurality of food products can be loaded into said at least one operable drawer;
a pre-selectable heat temperature control to provide a heat temperature wherein the heat temperature corresponds to the safe serving temperature.
a timer indicator that counts down to zero from a pre-set time once said heat temperature control has been activated such that the food products are assured of having reached the pre-selectable heat temperature and then said timer counts upward until a pre-set maximum time for holding the food products at a hold temperature wherein consumers are prevented from selecting a food product that hasn't reached the proper safe serving temperature and consumers are also prevented from selecting a food product that has been held longer at the hold temperature wherein the food product may be degraded in quality.

2. The food product heating apparatus of claim 1 wherein said apparatus is associated with a roller grill so that the food products taken from said apparatus and placed on the roller grill to brown are assured of meeting health safety standards even if the food products are on the roller grill for insufficient time to otherwise heat the food products fast enough to meet consumer demands.

3. The food product heating apparatus of claim 2 where said apparatus is integrated into the roller grill wherein the food products can easily be transferred from said at least one operable drawer of said apparatus to the roller grill.

4. The food product heating apparatus of claim 2 wherein said apparatus is adapted to fit under the roller grill wherein the food products can easily be transferred from said at least one operable drawer of said apparatus to the roller grill.

5. The food product heating apparatus of claim 1 wherein the refrigerated food products can be heated from the refrigerated temperature to the heat temperature which is greater than or equal to 140° F. in 35 minutes or less.

6. The food product heating apparatus of claim 1 wherein said at least operable drawer has an operating temperature ranging from 250° F. to 425° F.

7. The food product heating apparatus of claim 1 wherein the maximum time for holding the food products at the hold temperature is up to 6 hours.

8. The food product heating apparatus of claim 1 where said apparatus is associated with a heated food product merchandiser

9. The food product heating apparatus of claim 1 where the hold temperature ranges from greater or equal to 140° F. to not more than 205° F.

10. The food product heating apparatus of claim 1 further comprising a first alarm and a ready indicator light that indicates the apparatus is ready to be loaded with food products.

11. The food product heating apparatus of claim 10 further comprising a second alarm that activates when the timer reaches zero and a hold indicator light illuminates to indicate that said apparatus is holding the food products at the hold temperature.

12. The food product heating apparatus of claim 11 wherein said second alarm reactivates when the timer reaches the maximum time for holding the food products and continues to signal until turned off by a user and the hold indicator light continues to continues to flash until heat to the apparatus is turned off.

13. The food product heating apparatus of claim 1 wherein the time for pre-heat is automatically adjusted corresponding to the pre-selected heat temperature.

14. The food product apparatus claim 1 wherein the time and temperature for the heat temperature and hold temperature can be adjusted by a user.
